(19) United States
(12) Patent Application Publication
(10) Pub. No.: US 2024/0325112 A1
(43) Pub. Date: Oct. 3, 2024

(54) CUTTING TOOL FOR REMOVING BROKEN ENDODONTIC INSTRUMENT

(71) Applicant: KING FAISAL UNIVERSITY, AL-AHSA (SA)

(72) Inventor: NAZARGI MAHABOB, AL-AHSA (SA)

(21) Appl. No.: 18/127,636

(22) Filed: Mar. 28, 2023

(51) Int. Cl. A61C 5/46; A61C 3/02

(52) U.S. Cl. CPC A61C 5/46; A61C 3/02

(57) ABSTRACT

The cutting tool for removing a broken endodontic instrument is an attachment for a low rpm dentist's drill. The cutting tool is a hollow shaft having a drill attachment end adapted for attachment to the head of the dentist's drill and a tooth-engaging end. The tooth-engaging end of the hollow shaft has a plurality of cutting teeth for removing dentin, pulp, and other material in the area around the broken endodontic instrument. The cutting teeth may extend axially from the end of the hollow shaft or may extend laterally from the end of the hollow shaft. The cutting teeth may be sharp on both sides or edges so that the hollow shaft may be rotated either clockwise or counterclockwise, as needed. The hollow shaft is preferably made from a flexible, biocompatible material, such as a nickel-titanium alloy.

### BACKGROUND

### 1. Field

The disclosure of the present patent application relates to dental instruments, and particularly to a cutting tool for removing a broken endodontic instrument.

### 2. Description of the Related Art

Practitioners in the field of dentistry are sometimes called upon to treat a patient having a cracked or broken tooth. The crack or break may be severe enough that it exposes the pulp inside the tooth to infection and inflammation, and if left untreated, may result in gum disease. In any event, the patient often experiences pain and discomfort, sensitivity when ingesting hot or cold food or beverages, and other symptomatic complaints. Typically, the treatment of choice is a root canal procedure, which is usually performed by an endodontist, followed by installation of a crown or other dental restoration by a dentist to provide some form of permanent protection against future infection or re-inflammation.

In a root canal procedure, an access hole is created in the crown using a drill. The pulp is removed and the canal is cleaned and disinfected down to the roots using tiny files and appropriate cleaning fluids and disinfectants. The canal is filled with gutta percha and a temporary filling may be used to cap the tooth. Afterward, a dentist will install a crown or perform other dental restoration to protect the tooth.

The tiny files used to remove the pulp are made from a nickel-titanium alloy or from stainless steel. Due to the length, width, curvature, and sometimes ledges of dentin formed in the canal, some root canals may be very tough to clean. If too much pressure is exerted or if the files or other small instruments are used too many times or for too long a period, the files or other instruments may fracture and separate, leaving a small piece in the canal. In some cases, the separated instrument may be left in the canal or easily removed, but if the broken piece prevents removal of the pulp or obstructs the canal, preventing proper cleaning and disinfection, it may be necessary to resort to some form of procedure to extract or remove the piece of the broken or separated instrument. A cutting tool to clear the area and loosen the broken endodontic instrument without damaging to tooth or root canal s that the broken endodontic instrument can be gripped and removed more easily would be useful. Thus, a cutting tool for removing broken endodontic instrument solving the aforementioned problems is desired.

### SUMMARY

The cutting tool for removing a broken endodontic instrument is an attachment for a low rpm dentist's drill. The cutting tool is a hollow shaft having a drill attachment end adapted for attachment to the head of the dentist's drill and a tooth-engaging end. The tooth-engaging end of the hollow shaft has a plurality of rectangular cutting teeth for removing dentin, pulp, and other material in the area around the broken endodontic instrument. The rectangular cutting teeth may extend axially from the end of the hollow shaft or may extend laterally from the end of the hollow shaft. The rectangular cutting teeth may be sharp on both sides or edges so that the hollow shaft may be rotated either clockwise or counterclockwise, as needed. The hollow shaft is preferably made from a flexible, biocompatible material, such as a nickel-titanium alloy. Since the drill is operated at low rpm or torque, dentin or pulp surrounding the broken endodontic instrument may be safely removed until the broken endodontic instrument is freed enough to permit its removal by an appropriate gripping instrument.

These and other features of the present subject matter will become readily apparent upon further review of the following specification and drawings.

### BRIEF DESCRIPTION OF THE DRAWINGS

FIG. 1 is a perspective view of a first embodiment of a cutting tool for removing broken endodontic instrument.

FIG. 2 is a perspective view of a second embodiment of a cutting tool for removing broken endodontic instrument.

Similar reference characters denote corresponding features consistently throughout the attached drawings.

### DETAILED DESCRIPTION OF THE PREFERRED EMBODIMENTS

The cutting tool for removing a broken endodontic instrument is an attachment for a low rpm dentist's drill. The cutting tool is a hollow shaft having a drill attachment end adapted for attachment to the head of the dentist's drill and a tooth-engaging end. The tooth-engaging end of the hollow shaft has a plurality of rectangular cutting teeth for removing dentin, pulp, and other material in the area around the broken endodontic instrument. The rectangular cutting teeth may extend axially from the end of the hollow shaft or may extend laterally from the end of the hollow shaft. The rectangular cutting teeth may be sharp on both sides or edges so that the hollow shaft may be rotated either clockwise or counterclockwise, as needed. The hollow shaft is preferably made from a flexible, biocompatible material, such as a nickel-titanium alloy. Since the drill is operated at low rpm or torque, dentin or pulp surrounding the broken endodontic instrument may be safely removed until the broken endodontic instrument is freed enough to permit its removal by an appropriate gripping instrument.

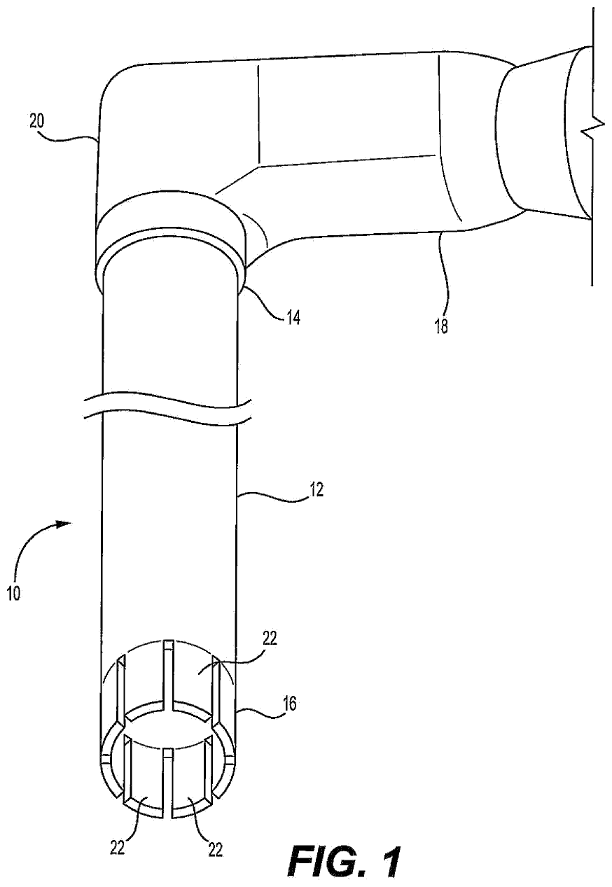

FIG. 1 illustrates an exemplary embodiment of a cutting tool 10 for removing a broken endodontic instrument. It will be understood that the drawing figures are not drawn to scale, but are more pictorial or schematic in nature in order to show the overall configuration and operation of the cutting tool. The cutting tool 10 has a hollow, elongate cylindrical shaft 12 having a drill attachment end 14 and an open end 16. The drill attachment end 14 is adapted to attaching the cutting tool 10 to the rotatable head 20 of a low rpm dentist's drill 18. The open end 16 of the hollow shaft 12 has a plurality of rectangular cutting teeth 22 extending therefrom. In this embodiment, the cutting teeth 22 extend axially from the circular open end 16 of the hollow shaft 12. The rectangular cutting teeth 22 are sharpened on each edge of the rectangular cutting teeth 22 so that the cutting tool 10 may be used to cut material away from the broken endodontic instrument by rotating the drill either clockwise or counterclockwise. The hollow shaft 12 is made from a flexible or malleable biocompatible material so that the shaft 12 may be bent to gain access to obstructed areas surrounding the broken endodontic instrument, if needed.

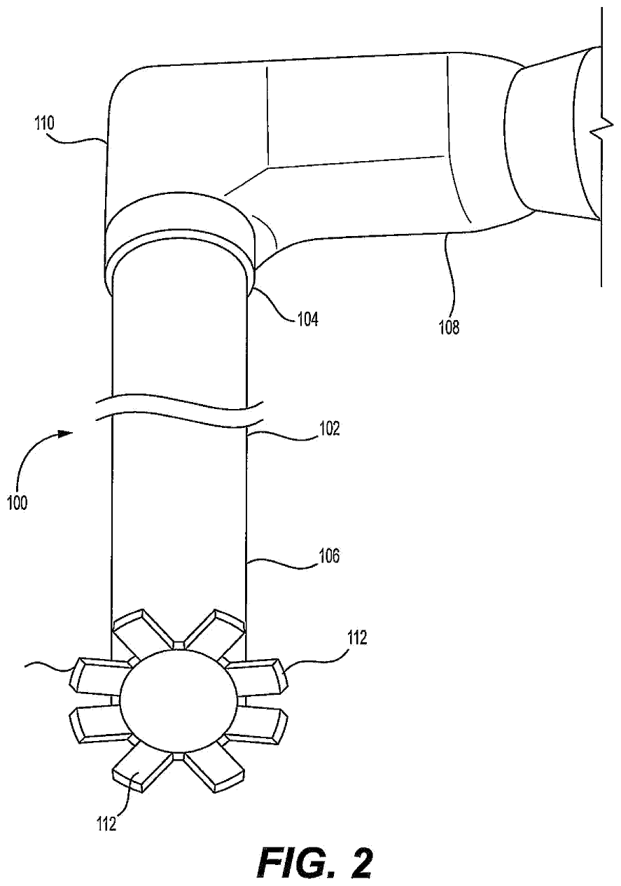

FIG. 2 illustrates another exemplary embodiment of a cutting tool 100 for removing a broken endodontic instrument. The cutting tool 100 has a hollow, elongate cylindrical shaft 102 having a drill attachment end 104 and an open end 106. The drill attachment end 104 is adapted to attaching the cutting tool 100 to the rotatable head 110 of a low rpm dentist's drill 108. The open end 106 of the hollow shaft 102 has a plurality of rectangular cutting teeth 112 extending therefrom. In this embodiment, the cutting rectangular teeth 112 extend laterally or orthogonally from the circular open end 106 of the hollow shaft 102. The rectangular cutting teeth 112 are sharpened on each edge of the rectangular cutting teeth 112 so that the cutting tool 100 may be used to cut material away from the broken endodontic instrument by rotating the drill either clockwise or counterclockwise. The hollow shaft 102 is made from a flexible or malleable biocompatible material so that the shaft 102 may be bent to gain access to obstructed areas surrounding the broken endodontic instrument, if needed.

It is to be understood that the cutting tool for removing broken endodontic instrument is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter

1. A cutting tool for removing a broken endodontic instrument,
comprising a hollow shaft adapted for attachment to a dentist's drill capable of rotating an attachment, the hollow shaft having a drill attachment end adapted for attachment to a head of the dentist's drill and an open end opposite the drill attachment end, the open end of the hollow shaft having a plurality of cutting teeth extending therefrom, said plurality of cutting teeth being spaced apart and having an axial gap therebetween on the open end of the hollow shaft, the cutting teeth being rectangular and configured for cutting dentin and pulp from a dental root canal in an area surrounding the broken endodontic instrument to permit removal by a gripping tool of the broken endodontic instrument from the dental root canal, wherein a size of the drill attachment end of the hollow shaft is equal to a size of the open end of the hollow shaft.

2. The cutting tool for removing broken endodontic instrument according to claim 1, wherein said cutting teeth extend axially from the open end of said hollow shaft.

3. The cutting tool for removing broken endodontic instrument according to claim 1, wherein said cutting teeth extend laterally from the open end of said hollow shaft.

4. The cutting tool for removing broken endodontic instrument according to claim 1, wherein said hollow shaft is made from a flexible, biocompatible metal alloy so that the hollow shaft may be bent to gain access to an area surrounding the broken endodontic instrument in a dental root canal.

5. The cutting tool for removing broken endodontic instrument according to claim 1, wherein said cutting teeth have cutting edges, each of the cutting edges being sharpened so that the cutting tool may cut dentin and pulp when rotated either clockwise or counterclockwise by the dentist's drill.

6. A system for removing a broken endodontic instrument from a dental root canal, the system comprising:
the cutting tool according to claim 1; and
a dentist's drill capable of rotating an attachment, the dentist's drill having a drill head capable of mounting said cutting tool thereon for rotating said cutting tool.
